(19) United States
(12) Patent Application Publication
(10) Pub. No.: US 2022/0147857 A1
(43) Pub. Date: May 12, 2022

(54) METHOD AND SYSTEM FOR ELIMINATING QUANTUM MEASUREMENT NOISE, ELECTRONIC DEVICE AND MEDIUM

(71) Applicant: BEIJING BAIDU NETCOM SCIENCE TECHNOLOGY CO., LTD., Beijing (CN)

(72) Inventors: Kun Wang, Beijing (CN); Yuao Chen, Beijing (CN); Xin Wang, Beijing (CN)

(73) Assignee: BEIJING BAIDU NETCOM SCIENCE TECHNOLOGY CO., LTD., Beijing (CN)

(21) Appl. No.: 17/581,850

(22) Filed: Jan. 21, 2022

(30) Foreign Application Priority Data
Mar. 15, 2021 (CN) 202110276285.1

(51) Int. Cl. G06N 10/20

(52) U.S. Cl. CPC G06N 10/20

(57) ABSTRACT

A method includes: determining a maximum number Z of times for executing a measuring device continuously; operating the quantum computer to perform, for each integer k in a set {0, 1, . . . , K} comprising Z integers, M₁ quantum computation processes to generate, for each quantum computation process, of the M₁ quantum computation processes, an intermediate measurement result, wherein, in each quantum computation process, the quantum computer is operated to generate an n-qubit quantum state p, and continuously execute the measuring device for k+1 times, so as to obtain the intermediate measurement result of the quantum computation process; operating a classical computer to compute an average measurement result of the M₁ quantum computation processes; and operating the classical computer to determine, by means of Neumann series based on the average measurement result(s) corresponding to all the integers k, unbiased estimation of a computed result of eliminating quantum measurement noise.

### CROSS REFERENCE TO RELATED APPLICATIONS

This application claims priority to Chinese Patent Application No. 202110276285.1, filed on Mar. 15, 2021, the contents of which are hereby incorporated by reference in their entirety for all purposes.

### TECHNICAL FIELD

The present disclosure relates to the field of computers, particularly relates to the technical field of quantum computers, and specifically relates to a method and system for eliminating quantum measurement noise, an electronic device, a computer readable storage medium and a computer program product.

### BACKGROUND

A quantum computer technology has been rapidly developed in recent years, however, the noise problem in a quantum computer will be unavoidable in the predicable future: heat dissipation in qubits or random fluctuation generated in a quantum physical process on a more bottom layer will result in state inversion or randomization of the qubits, and bias occurs when a measuring device reads a computed result, which are both possible to result in failure of a computation process.

### SUMMARY

The present disclosure provides a method and system for eliminating quantum measurement noise, an electronic device, a computer readable storage medium and a computer program product.

According to one aspect of the present disclosure, a method for eliminating quantum measurement noise of a measuring device is provided. The method includes: determining a maximum number Z of times for executing the measuring device continuously, wherein Z is a positive integer; operating the quantum computer to perform, for each integer k in a set {0, 1, . . . , K} comprising Z integers, wherein K=Z−1, M₁ quantum computation processes to generate, for each quantum computation process, of the M₁ quantum computation processes, an intermediate measurement result, wherein M₁ is a preset positive integer, and wherein, in each quantum computation process, the quantum computer is operated to generate an n-qubit quantum state ρ, and continuously execute the measuring device for k+1 times to measure the quantum state ρ, so as to obtain the intermediate measurement result of the quantum computation process, wherein n is a positive integer; operating a classical computer to compute an average measurement result of the intermediate measurement results of the M₁ quantum computation processes; and operating the classical computer to determine, by means of Neumann series based on the average measurement result(s) corresponding to all the integers k, unbiased estimation of a computed result of eliminating quantum measurement noise.

According to another aspect of the present disclosure, a system for eliminating quantum measurement noise of a measuring device is provided. The system includes: a quantum computer, configured to: in each quantum computation process, generate a n-qubit quantum state ρ, wherein n is a positive integer; a measuring device, configured to: in each quantum computation process, continuously measure, for k+1 times, the quantum state ρ generated by the quantum computer so as to obtain an intermediate measurement result of the quantum computation process; and a classical computer, configured to: for each integer k, receive the intermediate measurement result obtained by the measuring device in each quantum computation process so as to compute an average measurement result of M₁ times of quantum computation processes according to the intermediate measurement result obtained in each quantum computation process, wherein M₁ is a preset positive integer; and determine, by means of Neumann series based on the average measurement result(s) corresponding to all the integers k, unbiased estimation of a computed result of eliminating quantum measurement noise; wherein each k is an integer in a set {0, 1, . . . , K} including Z integers, and wherein Z is a positive integer and represents a maximum number of times that the measuring device performs continuous measurement, K=Z−1.

According to a further aspect of the present disclosure, an electronic device is provided. The electronic device includes: one or more processors; and a memory storing one or more programs configured to be executed by the one or more processors, the one or more programs including instructions for causing the electronic device to perform operations comprising: determining a maximum number Z of times for executing a measuring device continuously, wherein Z is a positive integer; operating the quantum computer to perform, for each integer k in a set {0, 1, . . . , K} comprising Z integers, wherein K=Z−1, M₁ quantum computation processes to generate, for each quantum computation process, of the M₁ quantum computation processes, an intermediate measurement result, wherein M₁ is a preset positive integer, and wherein, in each quantum computation process, the quantum computer is operated to generate an n-qubit quantum state ρ, and continuously execute the measuring device for k+1 times to measure the quantum state ρ, so as to obtain the intermediate measurement result of the quantum computation process, wherein n is a positive integer; computing an average measurement result of the intermediate measurement results of the M₁ quantum computation processes; and determining, by means of Neumann series based on the average measurement result(s) corresponding to all the integers k, unbiased estimation of a computed result of eliminating quantum measurement noise.

It should be understood that the contents described herein are not intended to identify key or important features of the embodiments of the present disclosure and are not used to limit the scope of the present disclosure either. Other features of the present disclosure will be easy to understand through the following specification.

### BRIEF DESCRIPTION OF THE DRAWINGS

The accompanying drawings show embodiments by way of example, construct a part of the specification, and serve to explain example implementations of the embodiments together with textual description of the specification. The shown embodiments are merely for the purpose of illustration, rather than limiting the scope of the claims. In all the accompanying drawings, the same reference numerals indicate elements which are similar, but are not necessarily same.

FIG. 1 is a schematic diagram showing an system in which various methods described herein may be implemented according to an embodiment of the present disclosure;

FIG. 2 is a flow diagram showing a method for eliminating quantum measurement noise of a measuring device according to an embodiment of the present disclosure;

FIG. 3 is a structural schematic diagram showing a measuring device with only classical bit output according to an embodiment of the present disclosure;

FIG. 4 is a schematic diagram showing serial connection of three measuring devices shown in FIG. 3 according to an embodiment of the present disclosure;

FIG. 5 is a structural schematic diagram showing a measuring device with classical and quantum mixed output according to an embodiment of the present disclosure;

FIG. 6 is a schematic diagram showing serial connection of three measuring devices shown in FIG. 5 according to an embodiment of the present disclosure;

FIG. 7 is a schematic diagram showing a scenario that a measuring device is continuously executed for k+1 times according to an embodiment of the present disclosure; and

FIG. 8 is a structural block diagram showing an example electronic device which may be used to implement embodiments of the present disclosure.

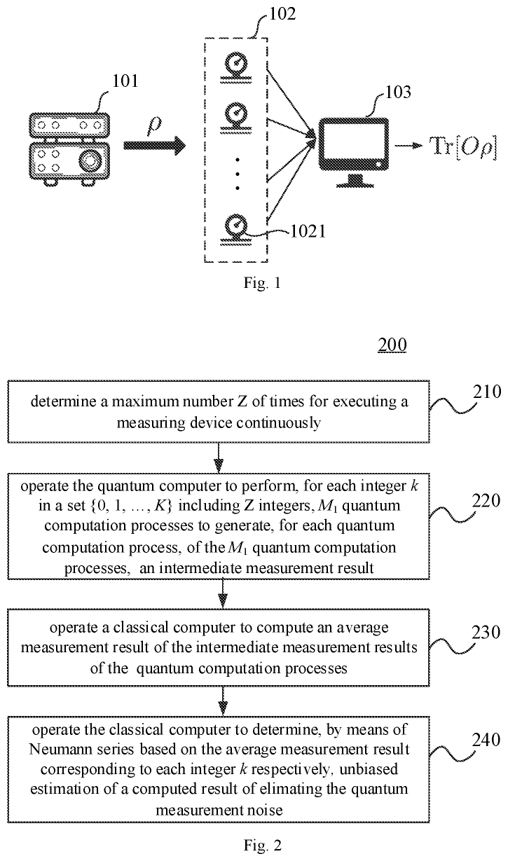

### DETAILED DESCRIPTION OF EMBODIMENTS

Embodiments of the present disclosure will be described below with reference to the accompanying drawings, wherein various details of the embodiments of the present disclosure are included for helping understanding, and they are only regarded as examples. Therefore, those of ordinary skill in the art should realize that various changes and modifications on the embodiments described herein may be made without departing from the scope of the present disclosure. Likewise, for clearness and conciseness, description for known functions and structures are omitted in the following description.

In the present disclosure, unless otherwise specified, terms such as “first” and “second” for describing various elements are not intended to limit a positional, sequential or importance relationship among these elements, and such terms are only used to distinguish one of the elements from another element. In some examples, a first element and a second element can refer to the same example of the elements. However, in some cases, they can also refer to different examples based on contextual description.

Terms used in the description of various examples in the present disclosure are only for the purpose of describing, rather than limiting, specific examples. Unless otherwise indicated clearly in the context, if the number of the elements is not specifically limited, there can be one or more elements. In addition, the term “and/or” used in the present disclosure covers any one or all of possible combination manners in listed items.

Embodiments of the present disclosure will be described in detail below with reference to the accompanying drawings.

So far, various different types of computers which are being applied use classical physics as the theoretical basis for information processing and are referred to as traditional computers or classical computers. A classical information system stores data or programs by adopting binary data bits which are physically easiest to implement, each of the binary data bits is represented by 0 or 1, is referred to as a bit and is used as a minimum information unit. The classical computers themselves have unavoidable weaknesses: firstly, the most basic limitation on energy consumption in a computation process: the minimum energy required by a logic element or a storage unit should be more than several times that of kT so that maloperation generated under thermal expansion are avoided; secondly, information entropy and heating energy consumption; and thirdly, when the wiring density of a computer chip is very high, according to a Heisenberg uncertainty relation, if the uncertainty amount of electronic positions is very small, the uncertainty amount of momentums may be very large. Electrons are not bound any more, and there will be a quantum interference effect which may even destroy the performances of chips.

A quantum computer is a type of physical device for high-speed mathematic and logical operation, storage and quantum information processing following the properties and laws of quantum mechanics. The device that processes and computes quantum information and operates quantum algorithms is a quantum computer. The quantum computer achieves a new information processing mode following a unique quantum dynamic law (particularly quantum interference). The quantum computer concurrently processes computing problems so as to have an absolute advantage than a classical computer in terms of speed. Each superposed component conversion achieved by the quantum computer is equivalent to a classical computation, all these classical computations are completed at the same time and are superposed according to a certain probability amplitude to obtain an output result of the quantum computer, and such computation is referred to as concurrent quantum computation. Concurrent quantum processing greatly increases the efficiency of the quantum computer so that the quantum computer can complete work, such as factorization of a very great natural number, that cannot be completed by the classical computer. Quantum coherence is essentially utilized in all superhigh-speed quantum algorithms. Therefore, by the concurrent quantum computation in which classical states are replaced with quantum states, an operation speed and an information processing function incomparable by those of the classical computer may be achieved, and meanwhile, a great number of operation resources are saved.

With the rapid development of a quantum computer technology, an application range of the quantum computer is wider and wider due to its strong computing power and relatively high operation speed. For example, chemical simulation refers to the process of mapping the Hamiltonian of a true chemical system to the physically operable Hamiltonian, and then, modulating the parameters and evolution time to find the eigenstate capable of reflecting the true chemical system. When simulating an N-electron chemical system on the classical computer, it involves the solution of a 2^{N}-dimensional Schrodinger equation, and the computation amount is increased exponentially with an increase of the number of electrons of the system. Therefore, the classical computer has limited effects on a chemical simulation problem. If such a bottleneck is desired to be broken through, it is necessary to depend on the high computing power of the quantum computer. A variational quantum eigensolver (VQE) is an efficient quantum algorithm for chemical simulation on quantum hardware, is one of most promising applications of the quantum computer in the near future, and develops many new chemical research fields. However, at the present stage, a noise measurement rate of the quantum computer obviously limits the ability of the VQE, and therefore, it is necessary to firstly handle the problem of quantum measurement noise.

A core computation process of the VQE algorithm is to estimate a desired value Tr[Oρ], wherein ρ is an n-qubit quantum state generated by a quantum computer, and an n-qubit observable quantity O is that the Hamiltonian of the true chemical system is mapped to the physically operable Hamiltonian. The above-mentioned process is the most ordinary mode for quantum computation to extract classical information and is a core step for reading the classical information from quantum information. Generally, it may be assumed that O is a diagonal matrix under a computing base, and therefore, in theory, the desired value Tr[Oρ] may be computed according to a formula (1):

Tr[Oρ]=Σᵢ₌₀²^{ⁿ}⁻¹O(i)ρ(i) formula (1)

wherein O(i) is an element in an ith row and an ith column of O (it is assumed that indexes of matrix elements are numbered from 0). The above-mentioned quantum computation process may be shown as FIG. 1, wherein a process that a quantum computer 101 generates an n-qubit quantum state ρ, and the quantum state ρ is measured by a measuring device 102 to obtain a computed result is performed for M times, a number Mᵢ of times that a result i is output is counted, it is estimated that ρ(i)≈Mᵢ/M, and then, Tr[Oρ] may be estimated by a classical computer 103. In an example, the measuring device 102 may measure the n-qubit quantum state ρ by n (positive integer) single qubit measuring devices 1021 to obtain a measurement result. The law of large numbers may ensure that the above-mentioned estimation process is correct when M is large enough.

However, due to the existence of quantum measurement noise (the measuring device 102 in FIG. 1 has noise), the counted number Mᵢ of times that the result i is output is inaccurate, and there is a bias between an actually estimated value Mᵢ/M and ρ(i), resulting in the presence of an error in Tr[Oρ] computed utilizing the above-mentioned formula. How to reduce or even eliminate influences of the quantum measurement noise to achieve unbiased estimation of Tr[Oρ] is an urgent problem to be solved.

At present, technical solutions for processing the quantum measurement noise of a measuring device mainly include as follows: a quantum error correction technology, a matrix inversion method and a quasi-probability decomposition method. In the quantum error correction technology, each logic qubit is composed of multiple physical bits, error correction is realized by virtue of redundant physical qubit resources, however, with the increment of the number of the physical bits, types of errors that may be generated by a system may be increased, meanwhile, an operation of encoding a plurality of qubits needs nonlocal interaction among the physical qubits, and therefore, in the experiment, the quantum error correction and a quantum gate are both difficult to achieve. The matrix inversion method and the quasi-probability decomposition method do not need additional physical bits, however, they depend on a preprocessing step: firstly, chromatographing a quantum measurement noise matrix A, and then, computing an inverse matrix A⁻¹ of the matrix. The number quantum states required for chromatographing the quantum measurement noise matrix A is O(2ⁿ), while the current best method for computing the inverse matrix has the complexity of O(2²^{ⁿ}) and is higher in computation difficulty and relatively long in preprocessing time, and therefore, the two methods do not have expansibility.

Therefore, according to an aspect of the present disclosure, an embodiment of the present disclosure provides a method for eliminating quantum measurement noise of a measuring device. The method includes that: determine a maximum number Z of times for executing a measuring device continuously, Z is a positive integer (step 210); operate the quantum computer to perform, for each integer k in a set {0, 1, . . . , K} including Z integers, wherein K=Z−1, M₁ quantum computation processes to generate, for each quantum computation process, of the M₁ quantum computation processes, an intermediate measurement result, M₁ is a preset positive integer(step 220); operate a classical computer to compute an average measurement result of the intermediate measurement results of the M₁ quantum computation processes(step 230); and operate the classical computer to determine, by means of Neumann series based on the average measurement result(s) corresponding to all the integers k, unbiased estimation of a computed result of eliminating the quantum measurement noise (step 240).

In each quantum computation process, the quantum computer is operated to generate an n-qubit quantum state ρ, and continuously execute the measuring device for k+1 times to measure the quantum state ρ, so as to obtain the intermediate measurement result of the quantum computation process, wherein n is a positive integer.

In the method according to the present disclosure, an inverse matrix of a quantum measurement noise matrix does not need to be computed, so that not only is the preprocessing time saved, but also the quantum measurement noise in the quantum computation processes can be effectively eliminated. Moreover, the method according to the present disclosure is unrelated to a number n of qubits so as to have better expansibility.

According to embodiments of the present disclosure, the problem that an inverse matrix A⁻¹ is difficult to compute may be solved based on a Neumann series. It is assumed that a spectral radius of a matrix A is smaller than 1, an expansion equation shown as a formula (2) may be obtained by virtue of the Neumann series:

A⁻¹=Σₖ₌₀^{∞}(l−A)^{k}=Σₖ₌₀^{K}cₖA^{K}+O((l−A)^{K+1}) formula (2)

wherein l is a unit matrix; and K is the number of expansion items selected according to the precision of the experiment; cₖ is a coefficient of an expansion item A^{k} with a mathematical expression shown as a formula (3):

$${c}_{k} = {( - 1 )}^{k} ( \begin{matrix}K + 1 \\ k + 1\end{matrix} ) \qquad formula ( 3 )$$

wherein

$$( \begin{matrix}n \\ k\end{matrix} )$$

is a binomial coefficient. It is assumed that K=5, a corresponding expansion equation is shown as a formula (4):

A⁻¹=6l−15A+20A²−15A³+6A⁴−A⁵+O((l+A)⁶) formula (4)

that is, first six items 6l,−15A,20A²,−15A³,6A⁴,−A⁵ in the expansion equation are used to approximate the target matrix A⁻¹.

Therefore, in the method for eliminating quantum measurement noise of the measuring device according to the present disclosure, the inverse matrix A⁻¹ of the noise matrix may be approximated in a manner of multiple measurements and does not need to be directly computed, and the method is unrelated to the number n of qubits so as to have better expansibility.

In order to process the quantum measurement noise based on the Neumann series method, it is necessary to set the maximum number Z of times for executing the measuring device continuously. According to some embodiments, the maximum number Z of times that the measuring device is continuously executed may be set according to a formula (5):

$$Z = \frac{{log}_{2} ɛ}{{log}_{2} ( 2 - 2 λ )} \qquad formula ( 5 )$$

wherein λ is a quantum noise parameter of the measuring device, and 2ε is a preset error tolerance of the computed result after the quantum measurement noise is eliminated, i.e. ε is a half of the preset error tolerance of the computed result after the quantum measurement noise is eliminated.

The quantum noise parameter λ may be used for describing the noise intensity of a qubit measuring device. Intuitively, the quantum noise parameter λ describes a correct condition when the measuring device with noise measures a computing base: the smaller the λ is, the higher the possibility that an error occurs in the measurement result is when the measuring device measures a computing base of a corresponding quantum state ρ. The parameter λ may be given by a measuring device supplier or may also be obtained after the measuring device is preprocessed to compute the quantum measurement noise matrix A. When the parameter λ is given by the measuring device supplier, the method according to the present disclosure does not need to obtain the quantum measurement noise matrix by the preprocessing process, and thus, the preprocessing time is further saved.

When the parameter λ is given by the measuring device supplier, according to some embodiments, the method 200 may further include that: obtain a quantum measurement noise matrix A of the measuring device; and obtain a minimum value on a main diagonal of the quantum measurement noise matrix A as the quantum noise parameter λ. In theory, the n-qubit measuring device may be equivalently described by a 2ⁿ×2ⁿ column random matrix A. Correspondingly, the quantum noise parameter λ may be obtained according to a formula (6):

$$λ = {min}_{i} A ( i ) ∈ [ 0.5 , 1 ] \qquad formula ( 6 )$$

wherein A(i) is an element in an ith row and an ith column of the noise matrix A.

According to some embodiments, the quantum measurement noise matrix A of the measuring device may be obtained by using a measurement calibration method. However, it should be understood that other analysis methods which may be used for obtaining the quantum measurement noise matrix A are also possible, which is not limited herein.

Generally, in order to simulate an n-electron chemical system, the corresponding measuring device is also required to be an n-qubit measuring device, wherein n is a positive integer. In order to measure n≥2 qubits at the same time, the corresponding measuring device may be a device obtained by serial connection of n single qubit measuring devices (as shown in FIG. 1), or may also be an n-qubit measuring device directly constructed experimentally, which is not limited herein.

In some embodiments, to assemble the n-qubit measuring device is to be assembled, the measuring device needs to be modeled. Firstly, the single qubit measuring devices are modeled. Generally, the measuring device receives a quantum state as an input to measure a computing base, and then outputs a result. According to the type of the output result, the qubit measuring devices may be divided into two types: a first type including only classical bit output and a second type including classical and quantum bit mixed output.

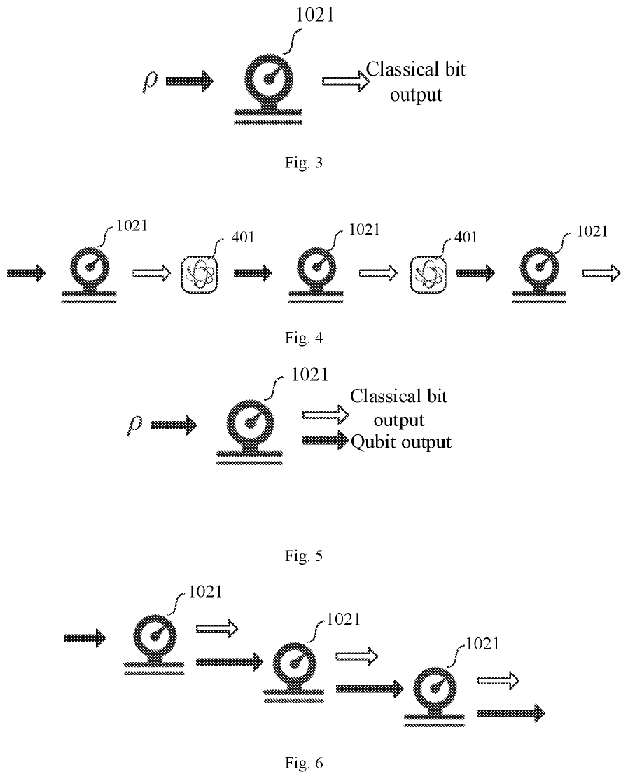

A structural schematic diagram showing a measuring device with only classical bit output may be shown as FIG. 3, wherein classical bit is output after the quantum state ρ is input to the qubit measuring devices 1021. In such a model, a plurality of qubit measuring devices 1021 may be serially connected using the concept “qubit reset”, that is, a corresponding quantum state is prepared according to a classical bit output result and is then used as an input to be provided to the next measuring device. FIG. 4 is a schematic diagram showing serial connection of three measuring devices. As shown in FIG. 4, a classical bit output by the former qubit measuring device 1021 is converted into a quantum state to be input to the next qubit measuring device 1021 by a quantum state preparation process 401 so that the serial connection of the plurality of qubit measuring devices 1021 is realized.

A structural schematic diagram showing a measuring device with classical and quantum bit mixed output is shown as FIG. 5. The quantum state ρ is input to the measuring devices 1021 and then output classical bit and qubit. In such a model, the serial connection of the plurality of qubit measuring devices 1021 is relatively simple: the output of the former measuring device is only required as the input of the next measuring device. FIG. 6 is a schematic diagram showing serial connection of three measuring devices. As shown in FIG. 6, the qubit output by the former measuring device 1021 is directly input to the next measuring device 1021 so that the serial connection of the plurality of measuring devices 1021 is realized.

After the measuring device is constructed, it is necessary to set the number M₁ of times of measuring the quantum state, that is, the number M₁ of times for performing the quantum computation process, so that when M₁ is great enough, the number M₁ of times of the output result i is counted, and then, ρ(i)≈Mᵢ/M₁ is correctly estimated. According to some embodiments, the number M₁ of times for performing the quantum computation process may be set according to a formula (7):

M₁=2KΔ log₂(2/δ)/ε² formula (7)

wherein

$$Δ = ( \begin{matrix}2 K + 2 \\ K + 1\end{matrix} ) - 1 ,$$

and δ is me confidence coefficient of eliminating the quantum measurement noise.

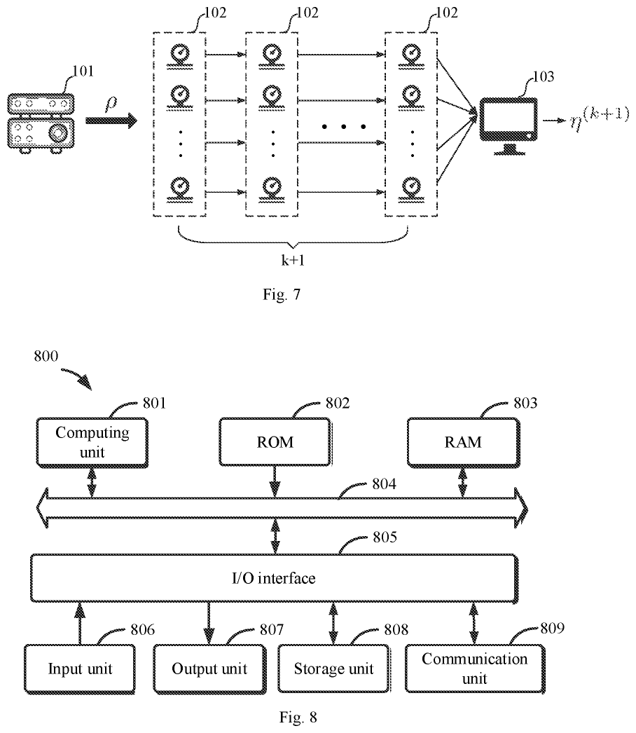

In order to implement the method according to the embodiments of the present disclosure, a schematic diagram showing a scenario that a measuring device is continuously executed for multiple times is shown as FIG. 7. Using the measuring device for (k+1) times means that the measuring device 102 is continuously executed for (k+1) times, rather than that there are (k+1) measuring devices 102, that is, an output of the measuring device 102 is used as an input for the next measurement until the (k+1) times of measurements are completed. Referring to FIG. 7, for each value of k=0, 1, . . . , K, perform the following quantum computation process for M₁ times: operate the quantum computer 101 to obtain an n (positive integer)-qubit quantum state ρ; and measure the n-qubit quantum state ρ by the measuring device 102 for (k+1) times, to obtain a computed result s^{m,k+1} that is obtained after the (k+1) times of measurements and store the computed result s^{m,k+1} in the classical computer 103, wherein m=1, . . . , M₁, and m is used for identifying each quantum computation process. The computed result s^{m,k+1} is a computed result obtained by each quantum computation process and is a bit string with a length n. After the quantum computation process is performed for M₁ times, M₁ computed results s^{m,k+1} will be obtained, wherein m=1, . . . , M₁.

According to some embodiments, an average computation result obtained after the quantum computation process is performed on each value k for M₁ times may be computed based on a formula (8):

$${η}^{( k + 1 )} = \frac{1}{{M}_{1}} {Σ}_{m = 1}^{{M}_{1}} O ( {s}^{m , k + 1} ) \qquad formula ( 8 )$$

wherein s^{m,k+1} is the computed result obtained after the m th measurement is completed, m=1, . . . , M₁, O is a qubit observable quantity, and O(i) is an element in an ith row and an ith column of O(indexes of rows and columns of elements are numbered from 0).

According to some embodiments, the unbiased estimation of the computed result after the quantum measurement noise is eliminated is computed based on a formula (9):

η=Σₖ₌₀^{K}cₖη^{(k+1)} formula (9)

wherein

$${c}_{k} = {( - 1 )}^{k} ( \begin{matrix}K + 1 \\ k + 1\end{matrix} ) .$$

By the method according to the embodiments of the present disclosure, influences of the quantum measurement noise to the VQE algorithm when chemical simulation is performed on quantum hardware may be effectively overcome. Therefore, an inverse matrix of a quantum measurement noise matrix does not need to be computed, so that the preprocessing time is saved. Moreover, the method is unrelated to the number of qubits so as to have better expansibility.

According to an embodiment of the present disclosure, further provided is a system for eliminating quantum measurement noise of a measuring device. As shown in FIG. 7, the system includes: a quantum computer 101, configured to: in each quantum computation process, generate an n-qubit quantum state ρ, wherein n is a positive integer; a measuring device 102, configured to: in each quantum computation process, continuously measure, for k+1 times, the quantum state ρ generated by the quantum computer 101 so as to obtain an intermediate measurement result of the quantum computation process; and a classical computer 103, configured to: for each integer k, receive the intermediate measurement result obtained by the measuring device in each quantum computation process so as to compute an average measurement result of M₁times of quantum computation processes based on the intermediate measurement result obtained in each quantum computation process, wherein M₁ is a preset positive integer; and determine, by means of Neumann series based on the average measurement result(s) corresponding to all the integers k, unbiased estimation of a computed result after the quantum measurement noise is eliminated, wherein k is an integer in a set {0, 1, . . . , K} including Z integers, Z is a positive integer and represents a maximum number of times that the measuring device performs continuous measurement, and K=Z−1.

According to some embodiments, the maximum number Z of times that the measuring device performs continuous measurement is determined according to the formula (5).

According to some embodiments, the quantum computer 101 is further configured to generate a n-qubit ground state in each preprocessing process, that is, a ground state having the same number of qubits as the quantum computation process; the measuring device 102 is further configured to measure the ground state generated by the quantum computer 101 in each preprocessing process so as to obtain a measurement result; and the classical computer 103 is further configured to: receive the measurement results obtained by the measuring device 102 in each preprocessing process so as to obtain a quantum measurement noise matrix of the measuring device 102 based on all measurement results obtained after 2ⁿ×M₂ times of preprocessing processes, wherein M₂ is a preset positive integer; and obtain a minimum value on a main diagonal of the quantum measurement noise matrix as a quantum noise parameter λ.

According to some embodiments, the number M₁ of times for performing the quantum computation process is determined according to the formula (7).

According to some embodiments, the classical computer 103 is configured to compute the average measurement result of the M₁ quantum computation processes based on the formula (8).

According to some embodiments, the classical computer 103 is configured to compute the unbiased estimation of the computed result after the quantum measurement noise is eliminated based on the formula (9).

According to some embodiments, the measuring device 102 may be formed by serial connection of n single qubit measuring devices.

Herein, operations of the quantum computer 101, the measuring device 102 and the classical computer 103 are respectively similar to the processes described as above, which are not described in detail herein.

According to an example embodiment of the present disclosure, further provided is an electronic device, including at least one processor; and a memory in communication connection with the at least one processor, wherein the memory stores an instruction capable of being executed by the at least one processor, and the instruction is executed by the at least one processor so as to enable the at least one processor to perform the above-mentioned method for eliminating the quantum measurement noise of the measuring device.

According to an example embodiment of the present disclosure, further provided is anon-transitory computer-readable storage medium storing a computer instruction, wherein the computer instruction is used for enabling a computer to perform the above-mentioned method for eliminating the quantum measurement noise of the measuring device.

According to an example embodiment of the present disclosure, further provided is a computer program product, including computer programs, wherein when the computer programs are executed by a processor, the above-mentioned method for eliminating the quantum measurement noise of the measuring device is implemented.

Referring to FIG. 8, a structural block diagram showing an electronic device 800 which may be used as a server or client of the present disclosure will be described now, which serves as an example of a hardware device which may be applied to various aspects of the present disclosure. The electronic device is intended to represent various forms of digital electronic computer devices such as a laptop computer, a desk computer, a working table, a personal digital assistant, a server, a blade server, a large-scale computer and other appropriate computers. The electronic device may further represent various forms of mobile devices such as a personal digital assistant, a cellular phone, a smart phone, a wearable device and other similar computing devices. Components, their connection and relationship as well as their functions shown herein are merely used as examples and are not intended to limit the implementation of the present disclosure described and/or required herein.

As shown in FIG. 8, the device 800 includes a computing unit 801 which may perform various appropriate actions and processing according to a computer program stored in a read only memory (ROM) 802 or a computer program loaded from a storage unit 808 to a random access memory (RAM) 803. In the RAM 803, various programs and data required by operation of the device 800 may be further stored. The computing unit 801, the ROM 802 and the RAM 803 are connected with each other by a bus 804. An input/output (I/O) interface 805 is also connected to the bus 804.

A plurality of components in the device 800 are connected to the I/O interface 805, and the device 800 includes an input unit 806, an output unit 807, a storage unit 808 and a communication unit 809. The input unit 806 may be any type of device capable of inputting information to the device 800, and the input unit 806 may receive input digital or character information and generate a key signal input related to user setting and/or function control of the electronic device, and may include, but is not limited to a mouse, a keyboard, a touch screen, a track pad, a trackball, an operating rod, a microphone and/or a remote controller. The output unit 807 may be any type of device capable of presenting information and may include, but is not limited to a display, a loudspeaker, a video/audio output terminal, a vibrator and/or a printer. The storage unit 808 may include, but is not limited to a magnetic disk and an optical disk. The communication unit 809 allows the device 800 to exchange information/data with other devices through a computer network such as the Internet and/or various telecommunication networks, and may include, but is not limited to a modem, a network card, an infrared communication device, a wireless communication transceiver and/or a chip set, such as a Bluetooth™ device, a 802.11 device, a WiFi device, a WiMax device, a cellular communication device and/or analogues thereof.

The computing unit 801 may be various general-purpose and/or special-purpose processing components with processing and computing abilities. Some examples of the computing unit 801 include, but are not limited to a central processing unit (CPU), a graphic processing unit (GPU), various special-purpose artificial intelligence (AI) computing chips, various computing units operating a machine learning model algorithm, a digital signal processor (DSP) as well as any appropriate processors, controllers, microcontrollers and the like. The computing unit 801 performs various methods and processing described above, such as the method 200. For example, in some embodiments, the method 200 may be implemented as a computer software program which is tangibly contained in a machine readable medium such as the storage unit 808. In some embodiments, parts or all of the computer programs may be loaded and/or installed on the device 800 by the ROM 802 and/or the communication unit 809. When the computer program is loaded into the RAM 803 and is executed by the computing unit 801, one or more steps of the method 200 described above may be performed. Alternatively, in other embodiments, the computing unit 801 may be configured in any other appropriate manner (for example, by virtue of firmware) to perform the method 200.

Various implementations of the system and the technology which are described above herein may be implemented in a digital electronic circuit system, an integrated circuit system, a field-programmable gate array (FPGA), an application specific integrated circuit (ASIC), an application specific standard product (ASSP), a system on a chip (SOC), a complex programmable logic device (CPLD), computer hardware, firmware, software, and/or combinations thereof. These various implementation manners may include that: the system and the technology are performed in one or more computer programs, the one or more computer programs may be executed and/or interpreted on a programmable system including at least one programmable processor, and the programmable processor may be a special-purpose and/or general-purpose programmable processor, and may receive data and instructions from a storage system, at least one input device and at least one output device and transmit the data and the instructions to the storage system, the at least one input device and the at least one output device.

Program codes for implementing the method of the present disclosure may be compiled by adopting any combination of one or more programming languages. These program codes may be provided to a processor or a controller of a general-purpose computer, a special-purpose computer or other programmable data processing devices, so that the program codes, when being executed by the processor or the controller, enable functions/operations specified in a flow diagram and/or a block diagram to be implemented. The program codes may be completely executed on a machine, partially executed on the machine, and used as an independent software package to be partially executed on the machine and partially executed on a remote machine, or completely executed on the remote machine or a server.

In the context of the present disclosure, the machine readable medium may be a tangible medium capable of including or storing programs to be used by an instruction execution system, device or equipment or to be used in combination with the instruction execution system, device or equipment. The machine readable medium may be a machine readable signal medium or a machine readable storage medium. The machine readable medium may include, but is not limited to an electronic, magnetic, optical, electromagnetic, infrared or semiconductor system, device or equipment, or any appropriate combinations thereof. A more specific example of the machine readable storage medium may include an electric connection based on one or more wires, a portable computer disk, a hard disk, a random access memory (RAM), a read only memory (ROM), an erasable programmable read only memory (EPROM or a flash memory), an optical fiber, a portable compact disc read only memory (CD-ROM), an optical storage device, a magnetic storage device or any appropriate combinations thereof.

In order to provide interaction with a user, the system and the technology which are described herein may be implemented on a computer. The computer is provided with a display device (e.g., CRT (Cathode-Ray Tube) for displaying information to the user or an LCD (Liquid Crystal Display) monitor), a keyboard and a pointing device (e.g., a mouse or a trackball), wherein the user may provide an input to the computer through the keyboard and the pointing device. Other types of devices may be further used for providing interaction with the user. For example, a feedback provided to the user may be any form of sensory feedback (e.g., visual feedback, auditory feedback, or tactile feedback); and moreover, the input from the user may be received in any form (including a sound input, a voice input or a tactile input).

The system and the technology which are described herein may be implemented on a computing system including a background component (e.g., a data server), or a computing system including a middleware component (e.g., an application server), or a computing system including a front end component (e.g., a user computer with a graphical user interface or a web browser, wherein a user may interact, through the graphical user interface or the web browser, with the implementations of the system and the technology which are described herein), or a computing system including any combination of the background component, the middleware component or the front end component. The components of the system may be interconnected by any form or medium of digital data communication (e.g., a communication network). Examples of the communication network include a local area network (LAN), a wide area network (WAN) and an Internet.

A computer system may include a client and a server. The client and the server are generally far away from each other and generally perform interaction through a communication network. A relationship between the client and the server is generated by computer programs running on a corresponding computer and having a client-server relationship therebetween.

It should be understood that the steps can be reordered, added or deleted by using various forms of processes described above. For example, all the steps recorded in the present disclosure can be performed concurrently or orderly or in different orders as long as a desired result in the technical solutions of the present disclosure can be realized, which is not limited herein.

Although the embodiments or examples of the present disclosure have been described with reference to the accompanying drawings, it should be understood that the above-mentioned method, system and devices are only embodiments or examples, the scope of the present disclosure is limited by the authorized claims and an equivalent scope thereof, rather than these embodiments or examples. The various elements in the embodiments or examples can be omitted or substituted with equivalent elements. In addition, all the steps can be performed according to an order different from that described in the present disclosure. Further, the various elements in the embodiments or examples can be combined in various manners. Importantly, as a technology has evolved, many elements described herein can be substituted with equivalent elements appearing later than the present disclosure.

1. A method for operating a quantum computer, the quantum computer comprising a measuring device, the method comprising:
determining a maximum number Z of times for executing the measuring device continuously, wherein Z is a positive integer;
operating the quantum computer to perform, for each integer k in a set {0, 1, . . . , K} comprising Z integers, wherein K=Z−1, M₁ quantum computation processes to generate, for each quantum computation process, of the M₁ quantum computation processes, an intermediate measurement result, wherein M₁ is a preset positive integer, and wherein, in each quantum computation process, the quantum computer is operated to generate an n-qubit quantum state ρ, and continuously execute the measuring device for k+1 times to measure the quantum state ρ, so as to obtain the intermediate measurement result of the quantum computation process, wherein n is a positive integer;
operating a classical computer to compute an average measurement result of the intermediate measurement results of the M₁ quantum computation processes; and
operating the classical computer to determine, by means of Neumann series based on the average measurement result(s) corresponding to all the integers k, unbiased estimation of a computed result of eliminating quantum measurement noise.

2. The method of claim 1, wherein the maximum number Z of times for executing the measuring device continuously is determined according to a following formula:
$$Z = \frac{{log}_{2} ɛ}{{log}_{2} ( 2 - 2 λ )}$$
wherein λ is a quantum noise parameter of the measuring device, and 2ε is a preset error tolerance of the computed result after the quantum measurement noise is eliminated.

3. The method of claim 2, further comprising:
obtaining a quantum measurement noise matrix A of the measuring device; and
obtaining a minimum value on a main diagonal of the quantum measurement noise matrix A as the quantum noise parameter λ.

4. The method of claim 3, wherein the quantum measurement noise matrix A of the measuring device is obtained by using a measurement calibration method.

5. The method of claim 2, wherein the number M₁ of times for performing the quantum computation process is determined according to a following formula:
M₁=2KΔ log₂(2/δ)/ε²
wherein
$$Δ = ( \begin{matrix}2 K + 2 \\ K + 1\end{matrix} ) - 1 ,$$
and δ is a confidence coefficient of eliminating the quantum measurement noise.

6. The method of claim 1, wherein the average measurement result of the M₁ times of quantum computation processes is computed based on a following formula:
$${η}^{( k + 1 )} = \frac{1}{{M}_{1}} {Σ}_{m = 1}^{{M}_{1}} O ( {s}^{m k + 1} )$$
wherein s^{m,k+1} is the intermediate measurement result obtained in the mth quantum computation process, m=1, . . . , M₁, O is a qubit observable quantity, and O(i) is an element in an ith row and an ith column of O.

7. The method of claim 6, wherein the unbiased estimation of the computed result of eliminating the quantum measurement noise is computed based on a following formula:
η=Σₖ₌₀^{K}cₖη^{(k+1)},
wherein
$${c}_{k} = {( - 1 )}^{k} ( \begin{matrix}K + 1 \\ k + 1\end{matrix} ) .$$

8. A system for eliminating quantum measurement noise of a measuring device, comprising:
a quantum computer, configured to:
generate an n-qubit quantum state ρ in each quantum computation process, wherein n is a positive integer;
a measuring device, configured to:
continuously measure the quantum state ρ generated by the quantum computer for k+1 times in each quantum computation process, so as to obtain an intermediate measurement result of the quantum computation process; and
a classical computer, configured to:
for each integer k, receive the intermediate measurement result obtained by the measuring device in each quantum computation process so as to compute an average measurement result of M₁ times of quantum computation processes according to the intermediate measurement result(s) obtained in each quantum computation process, wherein M₁ is a preset positive integer; and
determine, by means of Neumann series based on the average measurement result(s) corresponding to all the integers k, unbiased estimation of a computed result of eliminating quantum measurement noise,
wherein each k is an integer in a set {0, 1, . . . , K} comprising Z integers, Z is a positive integer and is a maximum number of times that the measuring device performs continuous measurement, K=Z−1.

9. The system of claim 8, wherein the maximum number Z of times that the measuring device performs continuous measurement is determined according to a following formula:
$$Z = \frac{{log}_{2} ɛ}{{log}_{2} ( 2 - 2 λ )}$$
wherein λ is a quantum noise parameter of the measuring device, and 2ε is a preset error tolerance of the computed result of eliminating the quantum measurement noise.

10. The system of claim 8, wherein
the quantum computer is further configured to generate an n-qubit ground state in each preprocessing process;
the measuring device is further configured to measure the ground state generated by the quantum computer in each preprocessing process so as to obtain a measurement result; and
the classical computer is further configured to:
receive the measurement results obtained by the measuring device in each preprocessing process so as to obtain a quantum measurement noise matrix of the measuring device based on all measurement results obtained after 2ⁿ×M₂ times of preprocessing processes, wherein M₂ is a preset positive integer; and
obtain a minimum value on a main diagonal of the quantum measurement noise matrix as the quantum noise parameter λ.

11. The system of claim 9, wherein the number M₁ of times for performing the quantum computation process is determined according to a following formula:
M₁=2KΔ log₂(2/δ)/ε²
wherein
$$Δ = ( \begin{matrix}2 K + 2 \\ K + 1\end{matrix} ) - 1 ,$$
and δ is a confidence coefficient of eliminating the quantum measurement noise.

12. The system of claim 8, wherein the classical computer is configured to compute the average measurement result of the M₁ times of quantum computation processes based on a following formula:
$${η}^{( k + 1 )} = \frac{1}{{M}_{1}} {Σ}_{m = 1}^{{M}_{1}} O ( {s}^{m k + 1} )$$
wherein s^{m,k+1} is the intermediate measurement result obtained in the mth quantum computation process, m=1, . . . , M₁, O is an n-qubit observable quantity, and O(i) is an element in an ith row and an ith column of O.

13. The system of claim 12, wherein the classical computer is configured to compute the unbiased estimation of the computed result of eliminating the quantum measurement noise, based on a following formula:
η=Σₖ₌₀^{K}cₖη^{(k+1)}
wherein
$${c}_{k} = {( - 1 )}^{k} ( \begin{matrix}K + 1 \\ k + 1\end{matrix} ) .$$

14. The system of claim 8, wherein the measuring device is formed by serial connection of n single qubit measuring devices.

15. An electronic device, comprising:
one or more processors; and
a memory storing one or more programs configured to be executed by the one or more processors, the one or more programs including instructions for causing the electronic device to perform operations comprising:
determining a maximum number Z of times for executing a measuring device continuously, wherein Z is a positive integer;
operating the quantum computer to perform, for each integer k in a set {0, 1, . . . , K} comprising Z integers, wherein K=Z−1, M₁ quantum computation processes to generate, for each quantum computation process, of the M₁ quantum computation processes, an intermediate measurement result, wherein M₁ is a preset positive integer, and wherein, in each quantum computation process, the quantum computer is operated to generate an n-qubit quantum state ρ, and continuously execute the measuring device for k+1 times to measure the quantum state ρ, so as to obtain the intermediate measurement result of the quantum computation process, wherein n is a positive integer;
computing an average measurement result of the intermediate measurement results of the M₁ quantum computation processes; and
determining, by means of Neumann series based on the average measurement result(s) corresponding to all the integers k, unbiased estimation of a computed result of eliminating quantum measurement noise.

16. The electronic device of claim 15, wherein the maximum number Z of times for executing the measuring device continuously is determined according to a following formula:
$$Z = \frac{{log}_{2} ɛ}{{log}_{2} ( 2 - 2 λ )}$$
wherein λ is a quantum noise parameter of the measuring device, and 2ε is a preset error tolerance of the computed result of eliminating the quantum measurement noise.

17. The electronic device of claim 16, the operations further comprising:
obtaining a quantum measurement noise matrix A of the measuring device; and
obtaining a minimum value on a main diagonal of the quantum measurement noise matrix A as the quantum noise parameter λ.

18. The electronic device of claim 17, wherein the quantum measurement noise matrix A of the measuring device is obtained by using a measurement calibration method.

19. The electronic device of claim 16, wherein the number M₁ of times for performing the quantum computation process is determined according to a following formula:
M₁=2KΔ log₂(2/δ)/ε²
wherein
$$Δ = ( \begin{matrix}2 K + 2 \\ K + 1\end{matrix} ) - 1 ,$$
and δ is a confidence coefficient of eliminating the quantum measurement noise.

20. The electronic device of claim 15, wherein the average measurement result of the M₁ times of quantum computation processes is computed based on a following formula:
$${η}^{( k + 1 )} = \frac{1}{{M}_{1}} {Σ}_{m = 1}^{{M}_{1}} O ( {s}^{m k + 1} )$$
wherein s^{m,k+1} is the intermediate measurement result obtained in the mth quantum computation process, m=1, . . . , M₁, O is a qubit observable quantity, and O(i) is an element in an ith row and an ith column of O.
